(19) United States
(12) Patent Application Publication
(10) Pub. No.: US 2025/0219483 A1
(43) Pub. Date: Jul. 3, 2025

(54) ROTATING ELECTRICAL MACHINE ROTOR AND ELECTROMAGNETIC RETARDER AND GENERATOR ASSEMBLY

(71) Applicant: TELMA, Saint-Ouen-L'aumone (FR)

(72) Inventors: Mbarek Akafou, Les Mureaux (FR); Romuald Belance, Deuil La Barre (FR); Nicolas Quennet, Cormeilles En Parisis (FR); Rafik Lounis, CERGY (FR)

(21) Appl. No.: 18/990,771

(22) Filed: Dec. 20, 2024

(30) Foreign Application Priority Data
Dec. 27, 2023 (FR) 2315347

(51) Int. Cl. H02K 1/22; H02K 9/22

(52) U.S. Cl. CPC H02K 1/22; H02K 9/227; H02K 2213/03

(57) ABSTRACT

A rotating electrical machine rotor, the rotor being able to turn about a rotation axis, with a transverse plane being perpendicular to the rotation axis, the rotor including: an interior fixing ring; a cylindrical body having a peripheral face, wherein the cylindrical body and the interior fixing ring being coaxial; and fixing arms having a blade shape having two main faces, wherein the fixing arms comprising a distal portion connected to the cylindrical body, the distal portion being inclined so that the main faces of the distal end of the fixing arms are at an inclination angle between 40 degrees and 60 degrees inclusive to the radial plane.

### TECHNICAL FIELD OF THE INVENTION

The invention concerns a rotating machine rotor and in particular an electromagnetic retarder rotor for vehicles. The invention also concerns an electromagnetic retarder and generator assembly.

### BACKGROUND OF THE INVENTION

The rotor of electromagnetic retarder and generator assemblies generally includes an interior ring intended to be mounted on a rotary shaft, a lateral flange and a cylindrical body coaxial with the interior ring. The flange consists of a plate of annular shape that connects the interior ring to the cylindrical body. The cylindrical body constitutes the armature of the retarder.

Such a rotor is described in the patent application FR 18 55 848 filed in the name of the applicant. That rotor is entirely satisfactory. It would nevertheless be desirable to propose a more robust rotor.

A first aim of the present invention is to propose a more robust rotor. A second aim is to strengthen the ventilation of the windings of the retarder and the generator.

### BRIEF SUMMARY OF THE INVENTION

The present invention has for object a rotating electrical machine rotor, the rotor being able to turn about a rotation axis in a rotation direction relative to the stator, the rotation axis extending in an axial direction, the rotor including:
an interior fixing ring intended to be fixed to a rotary shaft,
a cylindrical body having a peripheral surface, the cylindrical body and the interior fixing ring being coaxial,
fixing arms connected to the interior fixing ring and to the cylindrical body in a connection zone; for each fixing arm, a tangential plane, a straight line segment and a transverse plane being defined; the tangential plane being tangential to the peripheral surface in the connection zone of the fixing arm; the transverse plane being perpendicular to the rotation axis and passing through the connection zone of the fixing arm; the straight line segment being contained in the tangential plane and the transverse plane;
   the fixing arms having a blade shape having a first main face situated on an upstream side of the rotor in the rotation direction, a second main face opposite the first main face, a first lateral face intended to face a stator, a second lateral face opposite the first lateral face, a first edge arranged between the second main face and the second lateral face; the fixing arms comprising a distal portion connected to the cylindrical body; each fixing arm being inclined so that the first edge of the distal end of the fixing arm is at an inclination angle between 40 degrees and 60 degrees inclusive, preferably 45 degrees, to the straight line segment.

The fixing arms advantageously make it possible to increase the cooling of the cylindrical body by ventilation and account for a mechanical strength enabling severe deformation of the cylindrical body to be prevented.

The features disclosed in the following paragraphs may optionally be employed. They may be employed independently of one another or in combination with one another:
As seen in the transverse plane the fixing arms preferably include a curved first section, a curved second section and a rectilinear third section, the first section, the curved second section and the third section being situated between the interior fixing ring and the cylindrical body, and the inclined distal portion comprises at least the third section.
The first section is preferably connected to the interior fixing ring and the first section has a first radius of curvature, the second section has a second radius of curvature, and the ratio between the first radius of curvature and the second radius of curvature is between 1.5 and 2.5 inclusive.
The distal portion of the fixing arms is preferably inclined relative to an inclination axis extending in a longitudinal direction of the distal portion of the fixing arm, the inclination axis being situated at the centre of the second lateral face.
The third section preferably extends over a length between 30 millimetres and 60 millimetres inclusive prior to its connection to the cylindrical body.
As seen in the transverse plane distal end of the fixing arms is preferably angularly offset toward the rear at an angle α between 50 degrees and 60 degrees inclusive relative to the proximal end in the rotation direction of the rotor relative to a stator.
The rotor preferably further includes cooling fins fixed to the peripheral surface of the cylindrical body and a ring coaxial with the cylindrical body, the ring capping only the cooling fins arranged on a central part of the peripheral surface, the cooling fins arranged on a first edge and on a second edge of the peripheral surface being open to the outside.
The peripheral surface is preferably delimited in the axial direction by an end, the ring comprising a lateral edge adjacent to the end of the peripheral surface, and the lateral edge of the ring is at a distance between 15 millimetres and 30 millimetres inclusive from the end of the peripheral surface, the distance being measured in the axial direction.
The distal end of the fixing arms is preferably connected to a lateral face connecting the cylindrical body to the peripheral surface of the cylindrical body and to a lateral face of the ring, the distal end of the fixing arms projecting perpendicularly to the peripheral surface of the cylindrical body so as to form a cooling fin able to direct air toward the peripheral surface of the cylindrical body.

The distal end of the fixing arm advantageously forms a fin that directs air toward the cooling channels of the cylindrical body.

The invention also has for object an electromagnetic retarder and generator assembly, the assembly including a stator and a rotor, the stator comprising an external face and an internal face, the external face carrying a retarder field winding arranged facing an interior surface of the cylindrical body, the internal face carrying a generator armature, the rotor having any of the features mentioned hereinabove, the cylindrical body forming a retarder armature, the interior fixing ring comprising a generator field winding disposed facing the internal face of the stator.

### BRIEF DESCRIPTION OF THE FIGURES

FIG. 1 is a side view of a rotor according to the invention.

FIG. 2 is a perspective view of a part of the rotor depicted in FIG. 1.

FIG. 3 is a side view of a part of the rotor depicted in FIG. 1.

FIG. 4 is a view from above of a part of the rotor depicted in FIG. 1.

FIG. 5 is a diagrammatic view in radial section of a part of an electromagnetic retarder and generator assembly comprising a rotor depicted in FIG. 1.

### DETAILED DESCRIPTION OF THE INVENTION

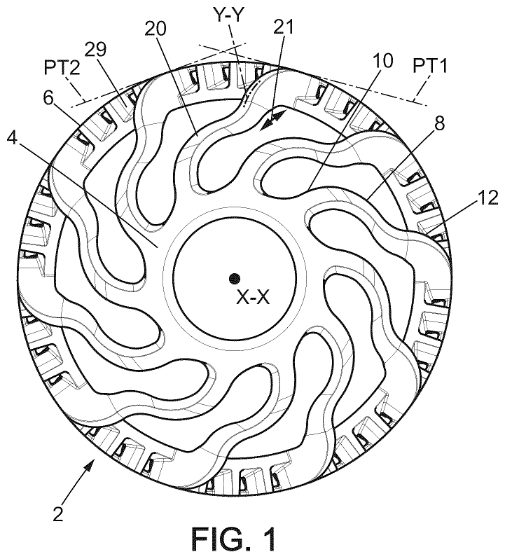

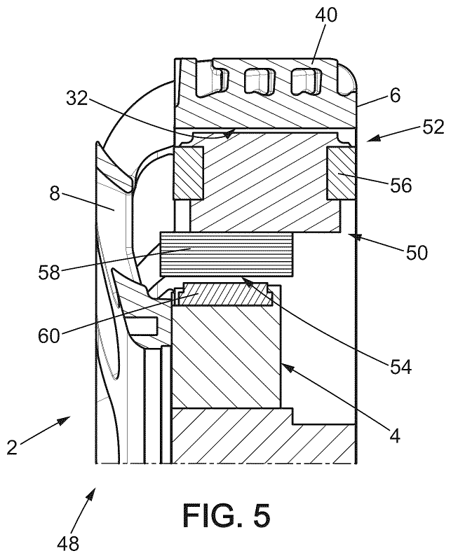

Referring to FIG. 1, the invention concerns a rotating electrical machine rotor 2. The rotor 2 is for example an electromagnetic retarder rotor for vehicles. This rotor may in particular be fitted in an electromagnetic retarder and generator assembly as depicted in FIG. 5.

The rotor 2 is able to turn about a rotation axis X-X extending in an axial direction A. For the purposes of the present description there is defined a transverse plane PR perpendicular to the rotation axis X-X.

The rotor 2 includes an interior fixing ring 4 intended to be fixed to a rotary shaft, not represented, a cylindrical body 6 and fixing arms 8 connected to the interior fixing ring and to the cylindrical body.

The interior fixing ring 4 and the cylindrical body 6 are coaxial.

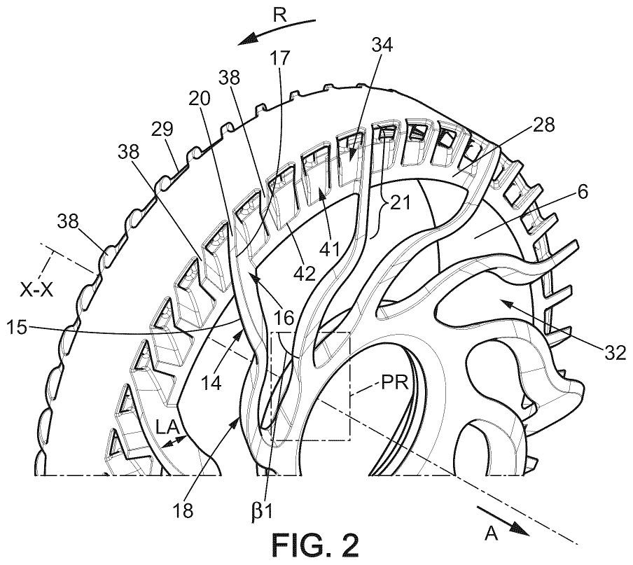

Referring to FIG. 2, the cylindrical body 6 is in the form of a sleeve. The cylindrical body 6 comprises a connecting lateral face 28, a free lateral face 29 opposite the connecting face, a peripheral surface 30 and an interior surface 32.

The connecting lateral face 28 is the face to which the fixing arms 8 are connected. The fixing arms 8 are connected to the connecting lateral face 28 of the cylindrical body 6 in connection zones 27. The transverse plane PR passes through the connection zones 27 of the cylindrical body 6.

For each fixing arm 8 there is defined a plane PT1, PT2 tangential to the peripheral surface 30 at a point in the connection zone 27, as can be seen in FIG. 1. For each fixing arm 8 there is defined a straight line segment containing a tangential plane and the transverse plane PR. For a fixing arm 8 a straight line segment D1 is therefore contained in the tangential plane PT1 and the transverse plane PR. For another fixing arm 8 a straight line segment D2 is contained in the tangential plan PT2 and the transverse plane PR.

The peripheral surface 30 comprises a first edge 34 adjacent to the connecting lateral face and a second edge 36 opposite the first edge. The first edge 34 of the peripheral surface 30 is delimited in an axial direction by an end 42. The peripheral surface 30 is a radially external surface.

In the example depicted by way of non-limiting example the rotor includes ten fixing arms. The fixing arms are regularly distributed around the interior ring.

Each fixing arm comprises a proximal end 10 connected to the fixing interior ring and distal end 12 connected to cylindrical body.

As seen in the transverse plane PR the distal end 12 of the fixing arms is angularly offset in the upstream direction (rearwardly) relative to the proximal end 10 in the rotation direction R of the rotor relative to a stator. This offset α is between 50 degrees and 60 degrees inclusive.

The fixing arms 8 have a blade or band shape. They have a first main face 16, a second main face 14 parallel to and opposite the first main face, a first lateral face 18 intended to face a stator and a second lateral face 20 opposite the first lateral face. The first main face 16 is situated on the upstream (rear) side of the rotor in the rotation direction R of the rotor relative to a stator. In other words a vector normal to the first main face 16 is directed in an opposite direction to the rotation direction R. The second main face 14 is situated on the downstream (front) side of the rotor in the rotation direction R of the rotor relative to a stator. In other words a vector normal to the second main face 16 is directed in the rotation direction R. A first edge 15 is arranged between the second main face 14 and the second lateral face 20. A second edge 17 is arranged between the first main face 16 and the second lateral face 20. The first edge 15 at the proximal end 10 of the fixing arms is at an angle β1 between 25 degrees and 35 degrees inclusive to the transverse plane PR. The angle β1 is preferably equal to 30 degrees.

For each fixing arm the first edge 15 of the distal end 12 of the fixing arm is at an inclination angle β2 between 40 degrees and 60 degrees inclusive to the straight line segment D1, the straight line segment D1 being contained within the transverse plane PR and the tangential plane PT1 in the connection zone 27 of that fixing arm 8. The inclination angle β2 is preferably equal to 45 degrees.

The fixing arms 8 include a distal portion 21 connected to the cylindrical body 6. The distal portion 21 is inclined relative to an inclination axis Y-Y. The inclination axis Y-Y extends in a longitudinal direction of the distal portion of the fixing arms. The inclination axis Y-Y is preferably situated at the centre of the second lateral face 20, as depicted in FIG. 1.

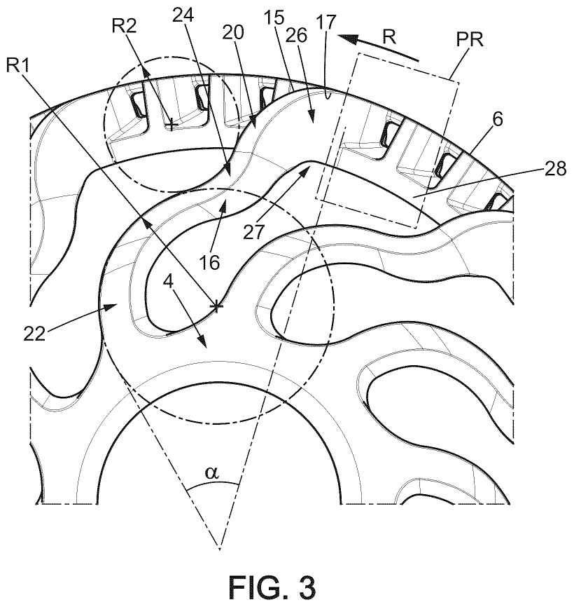

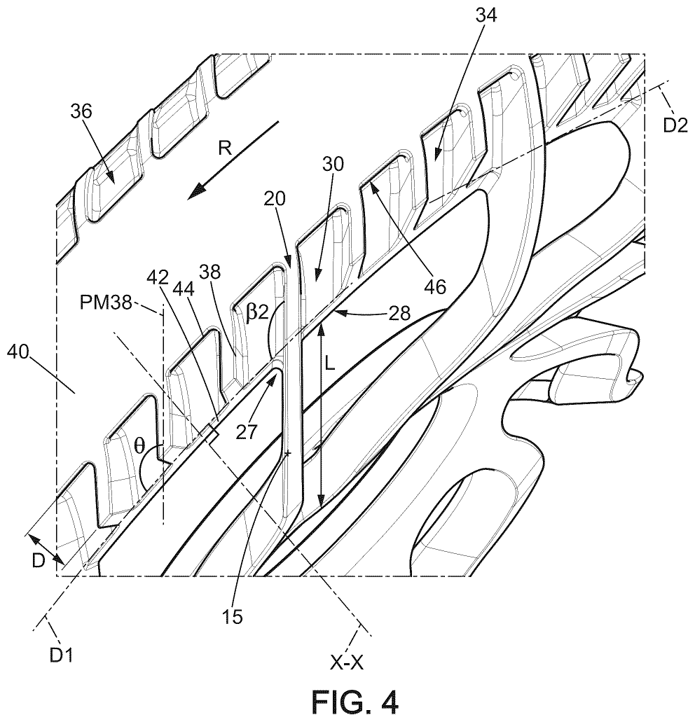

Referring to FIG. 3, as seen in the transverse plane PR the fixing arms 8 include a curved first section 22, a curved second section 24 and a rectilinear third section 26. The first section 22 is connected to the interior fixing ring 4. The first section, the second section and the third section 26 are situated between the interior fixing ring 4 and the cylindrical body 6. In particular, as can be seen in FIG. 4, the rectilinear third section extends over a length L between 30 millimetres and 60 millimetres inclusive prior to its connection to a connecting lateral face 28 of the cylindrical body. The third section 26 is then extended in a rectilinear manner over a peripheral surface 30 of the cylindrical body.

In the first embodiment depicted in the figures the inclined distal portion 21 of the fixing arms corresponds to the third section. In other words the fixing arms begin to be inclined starting from the junction between the curved second section and the rectilinear third section. The fixing arms are progressively inclined more and more throughout the length of the third section.

In accordance with a second embodiment the inclined distal portion 21 of the fixing arms corresponds to the second section and to the third section. In this embodiment the inclination of the fixing arms begins from the point of inflection between the first section and the second section. The fixing arms are progressively inclined more and more over the second section and over the third section.

The first section 22 is curved in an opposite direction to the rotation direction R of the rotor relative to the stator. In other words a vector normal to its concave surface is directed in a direction opposite to the rotation direction R of the rotor.

The second section 24 is curved in an opposite direction to the first section 22. The first section 22 and the second section 24 form an S. The arms include a point of inflection between the first section 22 and the second section 24.

The first section 22 has a first radius of curvature R1. The second section 24 has a second radius of curvature R2. The first and second radii of curvature are shown and measured along the same main face 16. The ratio between the first radius of curvature R1 and the second radius of curvature R2 is between 1.5 and 2.5 inclusive.

$$1.5 < \frac{R 1}{R 2} < 2.5$$

This shape makes it possible to reduce the plastic deformation of the fixing arms at the same time as providing ventilation of the cylindrical body and the windings of the stator. The blade shape of the fixing arms as well as their inclination and their direction make it possible to ventilate the cylindrical body and the windings of the stator. This shape of the fixing arms also makes it possible to reduce aerodynamic losses and consequently enhances the electrical cost-effectiveness of the rotating electrical machine including such a rotor.

The cylindrical body 6 comprises cooling fins 38 fixed to the peripheral surface 30 of the cylindrical body. The cooling fins 38 are the shape of a curved blade.

The cooling fins 38 are disposed parallel to one another in at least two rows.

The cooling fins 38 of a first row are aligned along the first edge 34.

A vector normal to the concave face of the cooling fins 38 of the first row is directed in the rotation direction R of the rotor relative to the stator. The cooling fins are therefore able to direct a greater quantity of air toward the peripheral surface 30 of the cylindrical body.

Cooling fins 38 are disposed parallel to one another in a second row aligned along the second edge 36.

A vector normal to the concave face of the cooling fins 38 of the second row is directed in an opposite direction to the rotation direction R of the rotor. The evacuation of air is therefore accelerated.

The median plane PM of the cooling fins 38 of the first and second rows is oriented at an angle θ between 40 degrees and 60 degrees inclusive to the transverse plane PR. The angle θ is preferably substantially equal to 45 degrees.

The rotor 2 preferably further includes other cooling fins disposed parallel to one another in one of more other rows arranged between the cooling fins of the first row and the cooling fins of the second row.

The distal end 12 of the fixing arms preferably projects perpendicularly to a peripheral surface 30 of the cylindrical body so as to form a cooling fin able to direct air toward the peripheral surface of the cylindrical body.

The rotor 2 preferably further includes a ring 40 coaxial with the cylindrical body. The ring 40 forms with the cooling fins cooling channels 41.

In the preferred embodiment depicted in the figures the ring 40 caps only the cooling fins disposed on a central part of the peripheral surface 30.

The cooling fins 38 arranged on the first edge 34 and on the second edge 36 of the peripheral surface are open to the outside. In other words a part of the cooling fins 38 arranged on the first edge 34 and the second edge 36 of the peripheral surface is not covered by the ring 40.

The ring 40 is delimited by a lateral edge 44 adjacent to the end 42 of the peripheral surface. The lateral edge 44 of the ring is preferably at a distance D between 15 millimetres and 30 millimetres inclusive from the end 42 of the peripheral surface, this distance D being measured only in the axial direction A.

The distal end 12 of the fixing arms is preferably also connected to a lateral face 46 of the ring. As can be seen in FIG. 2 the distal end 12 of the main faces of the fixing arms therefore has a width LA greater than the height of the ventilation channels 41. The second lateral face 20 of the distal end 21 of the fixing arms is flush with the exterior face 41 of the ring. The first lateral face 18 of the distal end of the fixing arms is flush with the interior surface 32 of the cylindrical body.

Referring to FIG. 5, the invention also concerns an electromagnetic retarder and generator assembly 48. This assembly includes a rotor 2 and a stator 50. The rotor 2 has the features referred to hereinabove.

The stator 50 comprises an external face 52 and an internal face 54. The external face 52 carries a retarder field winding 56 arranged facing an interior surface 32 of the cylindrical body. The internal face 54 carries a generator armature 58. The cylindrical body 6 of the rotor 2 forms a retarder armature. The interior fixing ring 4 comprises a generator field winding 60 disposed facing the internal face 54 of the stator.

1. A rotating electrical machine rotor, wherein the rotor being able to turn about a rotation axis in a rotation direction relative to a stator, the rotation axis extending in an axial direction, the rotor comprising:
an interior fixing ring intended to be fixed to a rotary shaft;
a cylindrical body having a peripheral surface, the cylindrical body and the interior fixing ring being coaxial; and
fixing arms connected to the interior fixing ring and to the cylindrical body in a connection zone; for each fixing arm, a tangential plane, a straight line segment and a transverse plane being defined; the tangential plane being tangential to the peripheral surface in the connection zone of the fixing arm; the transverse plane being perpendicular to the rotation axis and passing through the connection zone of the fixing arm; the straight line segment being contained in the tangential plane and the transverse plane;
the fixing arms having a blade shape having a first main face situated on an upstream side of the rotor in the rotation direction, a second main face opposite the first main face, a first lateral face intended to face a stator, a second lateral face opposite the first lateral face, a first edge arranged between the second main face and the second lateral face; the fixing arms comprising a distal portion connected to the cylindrical body; each fixing arm being inclined so that the first edge of the distal end of the fixing arm is at an inclination angle between 40 degrees and 60 degrees inclusive, preferably 45 degrees, to the straight line segment.

2. The rotor according to claim 1 in which, as seen in the transverse plane, the fixing arms include a curved first section, a curved second section and a rectilinear third section, the curved first section, the curved second section and the rectilinear third section being situated between the interior fixing ring and the cylindrical body, and in which the inclined distal portion comprises at least the rectilinear third section.

3. The rotor according to claim 1 in which the first section is connected to the interior fixing ring and in which the first section has a first radius of curvature, the second section has a second radius of curvature, and the ratio between the first radius of curvature and the second radius of curvature is between 1.5 and 2.5 inclusive.

4. The rotor according to claim 1 in which the distal portion of the fixing arms is inclined relative to an inclination axis extending in a longitudinal direction of the distal portion of the fixing arm, the inclination axis being situated at the centre of the second lateral face.

5. The rotor according to claim 1 in which the third section extends over a length between 30 millimetres and 60 millimetres inclusive prior to its connection to the cylindrical body.

6. The rotor according to claim 1 in which as seen in the transverse plane the distal end of the fixing arms is angularly offset toward the rear at an angle between 50 degrees and 60 degrees inclusive relative to the proximal end in the rotation direction of the rotor relative to a stator.

7. The rotor according to claim 1 further including cooling fins fixed to the peripheral surface of the cylindrical body and a ring coaxial with the cylindrical body, the ring capping only the cooling fins arranged on a central part of the peripheral surface, the cooling fins arranged on a first edge and on a second edge of the peripheral surface being open to the outside.

8. The rotor according to claim 7 in which the peripheral surface is delimited in the axial direction by an end, the ring comprising a lateral edge adjacent to the end of the peripheral surface, and in which the lateral edge of the ring is at a distance between 15 millimetres and 30 millimetres inclusive from the end of the peripheral surface, the distance being measured in the axial direction.

9. The rotor according to claim 7 in which the distal end of the fixing arms is connected to a lateral face connecting the cylindrical body to the peripheral surface of the cylindrical body and to a lateral face of the ring, the distal end of the fixing arms projecting perpendicularly to the peripheral surface of the cylindrical body so as to form a cooling fin able to direct air toward the peripheral surface of the cylindrical body.

10. An electromagnetic retarder and generator assembly comprising a stator and a rotor, the stator comprising an external face and an internal face, the external face carrying a retarder field winding arranged facing an interior surface of the cylindrical body, the internal face carrying a generator armature, the rotor being a rotor according to claim 1, the cylindrical body forming a retarder armature, the interior fixing ring comprising a generator field winding disposed facing the internal face of the stator.
